(19) United States
(12) Patent Application Publication
(10) Pub. No.: US 2018/0237617 A1
(43) Pub. Date: Aug. 23, 2018

(54) POLYURETHANE COMPOSITE MATERIAL

(71) Applicant: Covestro Deutschland AG, Leverkusen (DE)

(72) Inventors: Heiko HOCKE, Shanghai (CN); Dirk ACHTEN, Leverkusen (DE)

(21) Appl. No.: 15/752,637

(22) PCT Filed: Aug. 12, 2016
(86) PCT No.: PCT/EP2016/069231

§ 371 Date: Feb. 14, 2018

(30) Foreign Application Priority Data
Aug. 21, 2015 (EP) 15181956.2

(51) Int. Cl. C08K 7/14; C08G 18/79; C08G 18/24; C08L 75/04; C08G 18/32

(52) U.S. Cl. CPC C08K 7/14; C08G 18/792; C08G 18/3206; C08L 75/04; C08G 18/246

(57) ABSTRACT

The present invention relates to a polyurethane composite material comprising polyurethane and at least one filler, wherein the polyurethane is composed of a polyisocyanate component and a polyol component and the filler is a fibrous filler. Methods for producing the polyurethane composite material according to the invention and the use thereof as a structural component are also subject matter of the invention.

The present invention relates to a weather-resistant composite polyurethane material, to a process for the production thereof and to the use of the composite polyurethane material as structural component, for example for profiles, carriers and reinforcing struts, as reinforced lightweight component, for example for duct covers, plates, housings, luggage compartment or engine compartment covers, bumpers, visors and skirts and for pipes, pressure vessels and tanks.

Fiber-reinforced composite materials consisting of a polymeric matrix and a fibrous filler find use predominantly as lightweight construction materials, for example in motor vehicle construction, shipbuilding, aircraft construction the sports sector, the construction industry, the oil industry, and the electrical and energy sector. While the polymer matrix fixes the fibrous filler, ensures the transfer of load and protects the fibrous filler from environmental influences, the task of the fibrous filler is, for example, to guide the load along the fiber.

By means of suitable combination of polymeric matrix and fibrous filler, it is possible to obtain fiber-reinforced composite materials having improved mechanical and physical properties compared to the polymeric matrix.

To date, polyurethanes as polymeric matrix material had the disadvantage, compared to polymeric matrix materials which are conventionally used, for example epoxy resins, polyesters and polyvinyl esters, that the customary aromatic isocyanates such as MDI and TDI react very rapidly with polyols. The pot life required for the industrial manufacture of components in the various processes is often only realizable with difficulty and frequently requires additional technical complexity and thus increased process costs. Furthermore, the isocyanate component is moisture-sensitive and traces of water, for example in the feedstocks or on surfaces, such as those of the fibrous filler, lead to gas formation and hence blister formation in a side reaction. Moreover, the components are not weathering-stable and must be protected, for example by a coating, when used outdoors. In addition, the industrially produced aromatic isocyanates are frequently already colored brown, meaning that coloring with light colors or the setting of a particular hue is not possible or batch-dependent. For these reasons, the processing of polyurethanes is costly and complex, and requires high standards from the processor with respect to knowledge and experience. Therefore, in practice, polyurethanes have only a minor role as matrix material for composite materials.

To the extent that fiber-reinforced composite polyurethane materials are known from the prior art, for example WO 2014/14166861 A1, they seem to be in need of improvement with regard to their weathering resistance, glass transition temperature and transparency of the polyurethane matrix material. A high transparency of the polymeric matrix material is desirable, since a slight turbidity or base color of the matrix material is enough to make the coloring of the composite materials no longer optimally possible. A high glass transition temperature of the matrix material is desirable, too, in order to ensure optimal mechanical properties of the composite materials even at relatively high temperatures.

Numerous polyurethanes are known from the prior art. For example, WO 2012/013681 A1 describes polyisocyanates which have highly functional urethane groups and which are obtained by reaction of a di- or trialkanolamine with at least one aliphatic and/or cycloaliphatic polyisocyanate which has a functionality of ≥2 and which has at least one isocyanurate, biuret, uretdione and/or allophanate group, the molar ratio of NCO groups to OH groups being at least 3:1. The polyisocyanates having urethane groups find use in two-component polyurethane coatings, wherein they are reacted as prepolymers with binders, containing at least two groups reactive to isocyanate, to form polyurethanes.

EP 0 978 523 A1 describes processes for producing compact, transparent polyisocyanate poly-addition products. Here, isocyanate prepolymers are reacted with compounds reactive to isocyanates optionally in the presence of catalysts, auxiliaries and additives in a mold under a pressure from 1 to 20 MPa. The compounds reactive to isocyanates that are used are polyether or polyester polyalcohols. The transparent polyurethane products produced under pressure have a transmittance of above 90%, whereas the same composition without use of pressure leads to moldings having a transmittance of merely 62%. The disadvantages of the process are not only the complicated production of the isocyanate prepolymers and of the relatively high molecular weight polyols, but also the pressure which necessarily has to be applied during the production process.

DE 10 2009 005 711 A1 describes polyurethane potting compounds made from a relatively high molecular weight polyisocyanate component and a hydroxy-functional reaction partner, particular preference being given to using, as hydroxy-functional reaction partner, relatively high molecular weight addition products of ethylene oxide and/or propylene oxide onto glycerol, trimethylolpropane, ethylenediamine and/or pentaerythritol, i.e., polyether polyols. The test specimens produced have a transmittance of about 90%. The disadvantage of the described polyurethane potting compounds is that the relatively high molecular weight hydroxy-functional reaction partners containing ester and/or ether groups must be produced in a complicated manner in multiple reaction steps.

EP 2 016 111 B1 describes hyperbranched polyurethanes obtainable by reaction of a di- or polyisocyanate with an alkanetriol having ≥6 carbon atoms and optionally at least one further di- or polyol, the hydroxy- or isocyanate-functional polyurethanes being used as relatively high molecular weight core for the formation of relatively high molecular weight polymers, i.e., as prepolymer. A particular transparency of the hyperbranched polyurethanes is not described.

EP 2777915 A1 describe an aliphatic polyurethane-based, fiber-reinforced composite material which has been produced by pultrusion and features good weathering properties and excellent mechanical values. However, appropriate additives such as Tinuvin B 75 were also added here in particular in order to improve the weathering properties. No assessment of the pure aliphatic polyurethane matrix is possible, since no measurements were specified therefor. Various polyether polyols and aliphatic polyisocyanates were used, but only the rigid systems based on isophorone diisocyanate and dicyclohexylmethane 4,4′-diisocyanate achieved high Tg values. Moreover, because of the reaction characteristics, the short pot life and the use of monomer-containing isocyanates, it was necessary to work with an injection box, which means additional apparatus complexity and financial outlay.

Proceeding from the above-explained prior art, it is an object of the present invention to provide a composite material which has properties combining high heat distortion resistance and a high weathering resistance, and the matrix material of which is highly transparent and colorless, can be produced in a simple and cost-effective manner, and is optimally suitable for producing fiber-reinforced composite materials using production processes common in industry, such as pultrusion, reaction injection molding (RIM) and fiber winding.

According to the invention, this object is achieved achieved by a composite polyurethane material comprising polyurethane and at least one filler, the polyurethane being formed from a polyisocyanate component and a polyol component, wherein the polyisocyanate component consists of one or more polyisocyanates and the polyisocyanate component has an average NCO functionality per molecule of ≥2 and the polyol component has an OH content of ≥30% by weight and a content of ester and/or ether groups of less than 20% by weight and the polyol component consists of one or more polyols, the average OH functionality per molecule being ≥2, and wherein and the filler is a fibrous filler. It was found that, surprisingly, such composite polyurethane materials have remarkably high heat distortion resistances and weathering resistances. For instance, in measurements in accordance with the methods described in the experimental section, they exhibit weathering resistances of thousands of hours and heat distortion resistances of >100° C. Furthermore, as can also be gathered from the transmittance measurements in the experimental section, the polyurethanes used as polymeric matrix material have a high transparency with transmittances of about 90%. This makes it possible to optimally color the composite polyurethane materials according to the invention, particularly also with very light pigments such as white and yellow, and, additionally, to ensure a color adjustment of the formulation independently of the isocyanate batch used. Furthermore, the polyurethanes used according to the invention as matrix material have the advantage that the pot life can be adjusted over a relatively large range in line with the requirements of the processing method and the processing viscosities can also be adjusted in a simple manner via the processing temperature, the result being that the fiber-reinforced composite polyurethane materials according to the invention can be manufactured in a simpler and more economical manner in comparison with the conventional fiber-reinforced aromatic composite polyurethane materials. Because of the high weathering stability of the composite materials according to the invention, a protective coating as for other, conventionally produced fiber composite materials is not necessary, even in the case of outdoor use, resulting in a higher economic viability in practice.

The invention further provides a process for producing the composite polyurethane material according to the invention and for the use thereof as structural component, for example for profiles, rods, carriers and reinforcing struts, as reinforced lightweight component, for example for staircases, ladders, duct covers, plates, housings, luggage compartment or engine compartment covers, bumpers and visors, skirts, lamellae and for pipes, pressure vessels and tanks.

In the context of the present invention, materials are understood to mean finished polymer products which are no longer available as reactant for a further chemical reaction. Materials in the context of the invention are, in particular, not prepolymers. Materials in the context of the invention are understood to mean in particular polyurethanes which are already cross-linked, no longer have a melting point, are in principle no longer flowable or soluble, and exhibit a conversion of the NCO groups or OH groups of greater than 90%, preferably greater than 95%, particularly preferably greater than 99%, especially 100%.

In the context of the present invention, polyurethane is considered to mean organic compounds having urethane groups —NH—CO—O—.

A polyisocyanate is understood to mean an organic compound having NCO groups.

The polyisocyanate component in the context of the invention contains to an extent of over 50% by weight, by preference over 60% by weight, preferably over 70% by weight, particularly preferably over 80% by weight, especially over 90% by weight, very particularly preferably 100% by weight, at least one or more polyisocyanates which have in each case an NCO functionality per molecule of ≥2.

According to a preferred embodiment of the invention, the polyisocyanate component contains to an extent of over 50% by weight, by preference over 60% by weight, preferably over 70% by weight, particularly preferably over 80% by weight, especially over 90% by weight, very particularly preferably 100% by weight, at least one or more polyisocyanates which have in each case an NCO functionality per molecule of ≥3.

According to a further preferred embodiment of the invention, the average NCO functionality of the polyisocyanate component is ≥2, particularly preferably ≥3.

The NCO functionality of the polyisocyanate component can be calculated by dividing the total number of all NCO groups of the individual polyisocyanates of which the polyisocyanate component consists by the number of all molecules of the polyisocyanate component.

Without wishing to be bound to any scientific theories, the high functionality appears to lead to the formation of a very dense network in the composite, which prevents crystallization and thus allows a high transparency and a high glass transition temperature (Tg) and also leads to advantages in weathering characteristics.

Polyisocyanates suitable according to the invention are, for example, all organic aliphatic, cycloaliphatic aromatic or heterocyclic polyisocyanates known to a person skilled in the art. Preferably, the polyisocyanate is an aliphatic or cycloaliphatic compound. It is likewise preferred when the polyisocyanate component consists of aliphatic and/or cycloaliphatic polyisocyanates to an extent of over 80% by weight, by preference over 85% by weight, preferably over 90% by weight, especially over 95% by weight, particularly preferably over 99% by weight, very particularly preferably exclusively (to an extent of 100% by weight).

Examples of suitable polyisocyanates are the oligomers of aliphatic di- or triisocyanates, such as hexane diisocyanate (hexamethylene 1,6-diisocyanate, HDI), pentane 1,5-diisocyanate, butane 1,4-diisocyanate, 4,4′-methylenebis(cyclohexyl isocyanate), 3,5,5-trimethyl-1-isocyanato-3-isocyanatomethylcyclohexane (isophorone diisocyanate, IPDI), 4-isocyanatomethyl-1,8-octane diisocyanate, 1,3-bis(isocyanatomethyl)benzene (XDI), hydrogenated xylylene diisocyanate and also hydrogenated toluene diisocyanate.

Oligomers mean the adducts of the aforementioned di- and/or triisocyanates. They can be formed from the addition of isocyanate groups among one another to give uretdiones and/or isocyanurates and/or from reaction products and their downstream products of isocyanate groups with water and amines and with alcohols, the number of reacted di- or triisocyanates per molecule of oligomer being at least two. The oligomers contain furthermore reactive isocyanate groups. Furthermore, the oligomers in the context of the present invention are defined as compounds, the proportion of which having more than 11 reacted di- or triisocyanates per molecule is less than 40% by weight, preferably less than 25% by weight. The use of oligomers of aliphatic di- or triisocyanates has the advantage that they have a more attractive risk profile compared to the monomers. The vapor pressure of the virtually monomer-free oligomers is considerably lower than that of the monomers, meaning that there is practically no release into the ambient air. From the perspective of occupational safety, this is advantageous and facilitates the handling of the materials considerably. Moreover, the preceding oligomerization step already removes energy from the system and builds up molecular weight, meaning that the energy density is lower, the reaction is better controllable, and the volume shrinkage in the final crosslinking is low.

The polyisocyanate component can, in particular, have an NCO content ≥10% by weight and ≤61% by weight, preferably of ≥15% by weight and ≤50% by weight and particularly preferably of ≥18% by weight and ≤30% by weight. In this case, the NCO content indicates what the magnitude in percent by weight is of the molecular weight of the NCO groups based on the total molecular weight of the polyisocyanate component.

According to a further preferred embodiment, at least one polyisocyanate is a biuret, a uretdione, an allophanate, an isocyanurate (symmetrically or asymmetrically) of a di- or triisocyanate. Preference is given in this connection to selecting the di- or triisocyanate from the group consisting of hexane diisocyanate, isophorone diisocyanate, 4,4′-methylenebis(cyclohexyl isocyanate), xylylene diisocyanate, tetramethylxylylene diisocyanate, hydrogenated xylylene diisocyanate, hydrogenated toluene diisocyanate, pentane diisocyanate, norbornene diisocyanate or 4-isocyanatomethyl-1,8-octane diisocyanate.

According to a further embodiment of the invention, the polyisocyanate component can contain a urethane prepolymer or consist thereof, the urethane prepolymer having a content of ester and/or ether groups of less than 20% by weight, by preference less than 15% by weight, especially less than 10% by weight, preferably less than 5% by weight, especially less than 1% by weight. Very particularly preferably, the urethane prepolymer does not have any ester and/or ether groups.

Furthermore, it is particularly preferred when the polyisocyanate used is an isocyanurate of the di- or triisocyanates. It is yet further preferred when the polyisocyanate used is an isocyanurate of pentane diisocyanate, hexane diisocyanate or isophorone diisocyanate or a mixture of the isocyanurates thereof.

According to one embodiment of the invention, the polyisocyanates have a viscosity at 25° C. of over 1000 centipoise, preferably over 1050 centipoise.

Polyol in the context of the invention is understood to mean an organic compound which has OH groups.

The polyol component in the context of the invention consists, to an extent of over 50% by weight, by preference over 60% by weight, preferably over 70% by weight, particularly preferably over 80% by weight, especially over 90% by weight, very particularly preferably 100% by weight, of one or more polyols which have substantially an average OH functionality per molecule of ≥2, preferably ≥3.

According to a preferred embodiment, the polyol component has an average OH functionality of ≥2, preferably ≥3. The OH functionality of the polyol component can be calculated by dividing the total number of all OH groups of the individual polyols of which the polyol component consists by the number of all molecules of the polyol component.

A high functionality has the advantage that the formed polymeric matrix of the composite polyurethane material has a tight network and a high glass transition temperature (Tg). Practical experiments have shown that this has an advantageous effect on the weathering stability and the mechanical property profile.

Polyols suitable according to the invention are, for example, all organic aliphatic, cycloaliphatic, aromatic or heterocyclic polyols known to a person skilled in the art.

According to a particularly preferred embodiment of the invention, each individual polyol of which the polyol component consists has an OH functionality ≥2.

Examples of suitable polyols are glycol, propanediol, butanediol, 1,2,10-decanetriol, 1,2,8-octanetriol, 1,2,3-trihydroxybenzene, glycerol, 1,1,1-trimethylolpropane, 1,1,1-trimethylolethane, pentaerythritol or sugar alcohols.

Particularly preferred polyols are the purely aliphatic compounds glycol, glycerol, 1,1,1-trimethylolpropane, 1,1,1-trimethylolethane, pentaerythritol or sugar alcohols.

According to a particularly preferred embodiment of the invention, the polyol component used is glycerol.

The polyol component in the context of the invention furthermore has an OH content of ≥30% by weight.

In a development of the invention, the polyol component has an OH content ≥30% by weight and ≤60% by weight, preferably of 35% by weight and ≤60% by weight, particularly preferably of ≥40% by weight and ≤60% by weight, especially of ≥45% by weight and ≤58% by weight.

The OH content of the polyol component indicates in percent by weight how large the proportion of the molecular weight of the OH groups is based on the total molecular weight of the polyol component.

According to the invention, the polyol component has a content of ester and/or ether groups of less than 20% by weight, by preference less than 15% by weight, preferably less than 10% by weight, by preference less than 5% by weight, especially less than 1% by weight. Very particularly preferably, the polyol component does not have any ester and/or ether groups.

It has been found to be particularly advantageous in the context of the invention to keep the content of ester and/or ether groups low in order to achieve a tight network and thus a high glass transition temperature (Tg). This has an advantageous effect both on the weathering stability of the composite polyurethane material and on its mechanical stability at relatively high usage temperatures.

In the context of the invention, organic compounds having ether groups —C—O—C— are considered to be ether group-containing.

Considered to be ester group-containing in the context of the invention are organic compounds having ester groups —CO—O—, especially thus ester groups obtainable by condensation of carboxylic acid and hydroxy-functional compound (alcohol).

According to a further preferred embodiment of the invention, the polyol component can further have a content of amino groups of less than 9% by weight, preferably less than 5% by weight, especially less than 3% by weight, by preference less than 1% by weight. Particularly preferably, the polyol component does not have any amino groups.

The disadvantage of primary and secondary amino groups is that they are distinctly more reactive than hydroxyl groups and thus considerably reduce the pot life, i.e., the period in which the mixture of polyisocyanate component and polyol component still has a sufficiently low viscosity in order to allow processing by means of the common industrial processes for manufacturing fiber-reinforced composite material components. Although tertiary amino groups do not react with the isocyanate, they may have a catalytic effect and, in this way, greatly reduce the pot life. Moreover, they do not exhibit a sufficiently high weathering resistance, since they tend toward yellowing.

Pot life defines the time at a particular temperature at which the viscosity of the reaction mixture has doubled.

In the case of the reaction mixture according to the invention that is composed of polyisocyanate component and polyol component and also additives and catalysts, the pot life at 23° C. is, according to one embodiment, at least 20 min, preferably at least 30 min, particularly preferably at least 1 hour and especially at least 2 hours.

The molecular ratio of polyisocyanate component to polyol component can be set such that the ratio of the NCO groups to OH groups is in the range from 0.85:1.00 to 1.20:1.00 and preferably in the range from 0.9:1 to 1.1:1.00 and particularly preferably at 1.00:1.00.

According to a particularly preferred embodiment, the polyisocyanate component has an average NCO functionality ≤4 and/or the polyol component has an average OH functionality ≤6.

According to the invention, the average functionality of the reaction mixture composed of polyisocyanate component and polyol component is greater than 2.1, especially greater than 2.2, preferably greater than 2.3, especially preferably greater than 2.4, particularly preferably greater than 2.5, especially greater than 2.6, very particularly preferably greater than 2.7, especially greater than 2.8, advantageously greater than 2.9.

The average functionality of the reaction mixture can be calculated by forming the sum total of the average functionality of the polyol component and of the isocyanate component and dividing the result by two.

Fibrous fillers that are suitable according to the invention are, for example, all inorganic fibers, organic fibers, natural fibers or mixtures thereof that are known to a person skilled in the art.

In the context of the invention, a material having an aspect ratio of >5 is considered to be fiber. In this connection, the aspect ratio is defined as the ratio of the longest dimension divided by the smallest dimension of the material (e.g., length divided by diameter).

Examples of inorganic fibers that are suitable according to the invention are glass fibers, basalt fibers, boron fibers, ceramic fibers or whiskers, silica fibers and metallic reinforcing fibers. Examples of organic fibers that are suitable according to the invention are aramid fibers, carbon fibers, polyester fibers, nylon fibers, carbon nanotubes, polyethylene fibers and Plexiglas fibers. Examples of natural fibers that are suitable according to the invention are flax fibers, hemp fibers, wood fibers, nanocellulose and sisal fibers.

According to a preferred embodiment of the invention, the fibrous fillers used are glass fibers.

According to a further preferred embodiment of the invention, the fibrous fillers used are carbon fibers.

A composite polyurethane material in the context of the invention is a material which has a fiber content ≥5% by weight and ≤95% by weight, by preference ≥20% by weight and ≤90% by weight, particularly preferably of ≥40% by weight and ≤90% by weight and especially of ≥50% by weight and ≤85% by weight. If the fiber content is lower, the reinforcing effect is too low and the matrix properties predominate. If the fiber content is higher, the polyurethane resin amount is insufficient for binding the fibers to one another and the mechanical properties of the composite polyurethane material deteriorate.

According to a further embodiment of the invention, the composite polyurethane material can be modified on the surface. Because of the imprecision due to technical reasons or else as a result of specific adjustment in the mixing of the isocyanate component and polyol component, it is possible for functional residual groups that are still present to be used for the surface modification of the composite polyurethane material. All methods for surface modification that are known to a person skilled in the art are suitable. However, said surface modification does not have a significant influence on the volume properties of the composite polyurethane material, for example modulus E′, elongation or density.

The invention further provides a process for producing a composite polyurethane material according to the invention, in which, for example, the polyisocyanate component and the polyol component are mixed, optionally catalyst and/or additives are added, the resulting mixture is combined with the fibrous filler and optionally heated. The sequence of the mixing or of the contacting with the fiber can be chosen as desired or, if necessary, depending on the processing method.

Preferably, the process according to the invention is selected from infusion process, prepreg process, pultrusion process, precision winding process, i.e., so-called filament winding, RIM process and composite spray molding.

The polyisocyanate component and the polyol component can, for example, be mixed with the aid of various static or dynamic mixing apparatuses known to a person skilled in the art.

In a preferred embodiment of the process according to the invention, the polyisocyanate component and the polyol component are heated to a temperature from 10 to 90° C., preferably from 20 to 80° C. and particularly preferably from 30 to 60° C., before the mixing.

It is likewise preferred when, based on sum totals of the masses of the polyisocyanate component and of the polyol component, 0.0001 to 10% by weight, preferably 0.001 to 2% by weight and particularly preferably 0.003 to 0.030% by weight, of catalyst is added.

Examples of suitable catalysts are the typical urethanization catalysts as specified, for example, in Becker/Braun, Kunststoffhandbuch [Plastics handbook] volume 7, Polyurethane [Polyurethanes], section 3.4. The catalyst used can be in particular a compound selected from the group of amines, metal salts and metal organyls, preferably from the group of tin salts, tin organyls and of bismuth organyls and particularly preferably dibutyltin dilaurate and tin dioctoate.

The catalyst can be added either in diluted form with suitable solvents or in undiluted form to one of the two components. Preferably, the catalyst is premixed with one component without addition of solvent before said component is mixed with the other component.

Alternatively, the catalyst can also be deposited on the fiber, for example by impregnation of the fiber in a solvent containing the catalyst combined with subsequent drying, and can subsequently then be blended upon wetting of the fiber with the resin component.

As further components, it is possible to add various additives such as, for example, flame retardants, dyes, fluorescent substances, light stabilizers, antioxidants, thixotropic agents, demolding agents, adhesion promoters, light-scattering agents, fillers and optionally further auxiliaries and additives.

Optionally, the feedstocks are dried and degassed by suitable methods prior to mixing, in order to avoid unwanted side reactions and blister formation.

In the process according to the invention, it is advantageous when the polyisocyanate component and the polyol component and optionally the further components are mixed in the absence of water, since low amounts of moisture can lead to the formation of blisters. The residual water content in the mixture should therefore be kept sufficiently low that no defects occur. The water content of the mixture can be ≤1% by weight, especially ≤0.5% by weight, particularly preferably ≤0.1% by weight.

The process according to the invention can also be carried out using up to 20% by weight of organic solvents, though it is preferred when no solvents or only small amounts of solvents are used.

Preference is given to a process in which the content of solvent is less than 10% by weight over the course of the formation of polymer.

The invention further provides for the use of the composite polyurethane material as structural component, for example for profiles, rods, carriers and reinforcing struts, as reinforced lightweight component, for example for staircases, ladders, duct covers, plates, housings, luggage compartment or engine compartment covers, bumpers and visors, skirts, lamellae and for pipes, pressure vessels and tanks.

The invention is elucidated in detail hereinafter by examples.

The property profile of a component for outdoor use generally comprises many characteristic parameters, of which in turn the majority strongly depend on the exact use and the thus required standards and tests. Therefore, for simplification, the materials according to the invention were assessed by considering the glass transition temperature (Tg), the modulus E′ and, for weathering, the L or b value.

The glass transition temperature (Tg) is a good indicator of the temperature range up to which the component approximately retains its mechanical properties Above the glass transition temperature, the material becomes soft, i.e., the mechanical properties change dramatically, in many cases by several orders of magnitude. Since outdoor components are rapidly heated up to 80° C. by solar radiation, the glass transition temperature should reach distinctly over 80° C., by preference at least 90° C. or further preferably at least 100° C. and thereover.

The modulus E′ is a fixed mechanical value; the higher it is, the better it is. In the case of composite materials, it strongly depends on the fiber content, its nature and orientation. Moreover, it provides information about the interaction of the fiber with the matrix and in the fiber bundle.

The L or b value is a color value in the testing of weathering. What is often crucial is not so much the absolute level but more the relative change before and after weathering, since said change is also a measure of how the hue changes. A smallest possible change is striven for here.

Pot life was considered as process-relevant variable. This is the time within which the reactive material can be processed.

General Details:

All percentages, unless stated otherwise, are based on percent by weight (% by weight).

The ambient temperature of 23° C. at the time of conduct of the experiments is referred to as RT (room temperature).

The NCO or OH functionality of the various raw materials was determined by calculation in each case.

Test Methods:

The methods detailed hereinafter for determining the relevant parameters were employed for performing/evaluating the examples and are also the methods for determining the parameters relevant in accordance with the invention in general.

Determination of Yellowing by Means of Cie-Lab Measurement

After crosslinking and cooling, the composite material was removed from the mold and the measurement was conducted on the lower, smooth face of the material. For this purpose, a color-guide sphere spin colorimeter from BYK-Gardner GmbH with CIE L*a*b system scale, d/8° measurement geometry and D65/10° illuminant/observer was used. The value used corresponds to the arithmetic mean of 5 measurements.

Determination of Transmittance

The transmittance of the cured polyurethane materials was determined using a Byk-Gardner haze-gard plus instrument in line with the ASTM standard D-1003. The measurement was carried out on samples having a layer thickness of 1 cm.

Determination of Pot Life

Pot life was determined using a Physica MCR 51 rheometer (plate-plate) at the relevant temperature and at a shear rate of 10/s.

Determination of Glass Transition Temperature

Glass transition temperature (Tg) was determined with the aid of the DMA method (dynamic mechanical analysis) using a DMA—SEIKO SII EXSTAR 6100 DMS on free films or composite strips at an excitation frequency of 1 Hz.

Determination of Modulus E′

Modulus E′ was determined with the aid of the DMA method on composite strips using a DMA—SEIKO SU EXSTAR 6100 DMS at an excitation frequency of 1 Hz at 20° C.

Feedstocks

Desmodur® N 3600 is an HDI trimer (NCO functionality >3) with an NCO content of 23.0% by weight from Covestro Deutschland AG. The viscosity is 1200 mPas (DIN EN ISO 3219/A.3).

Desmodur® XP 2838 is a mixture of HDI oligomers and IPDI trimers (NCO functionality >2) and with an NCO content of 21% by weight from Covestro Deutschland AG. The viscosity is 3000 mPas (DIN EN ISO 3219/A.3).

Desmodur® XP 2489 is an HDI/IPDI trimer (NCO functionality >3) with an NCO content of 21.0% by weight from Covestro Deutschland AG. The viscosity is 22 500 mPas (DIN EN ISO 3219/A.3).

Glycerol (1,2,3-propanetriol) was sourced with a purity of 99.0% from Calbiochem.

1,1,1-Trimethylolpropane (TMP) was sourced with a purity of 97.0% from Aldrich.

Desmophen® 4011T is a trifunctional polyol from Covestro Deutschland AG, containing about 45% by weight of ether groups, about 17% by weight of OH groups and less than 0.15% by weight of water. Desmophen VP LS 2249/1 is a branched (2<F<3), short-chain polyester polyol from Covestro Deutschland AG with a hydroxyl content of 15.5%.

Dibutyltin dilaurate (DBTL) was sourced from Acros Chemicals under the name Tinstab BL277.

Ethylene glycol was sourced with a purity of >99% by weight from Bernd Kraft.

Hexane-1,2,6-triol was sourced with a purity of >97% by weight from ACROS.

Triethanolamine was sourced with a purity of >98% by weight from Abcr GmbH.

D-Sorbitol was sourced with a purity of >98% by weight from Sigma.

The woven glass fiber fabric was a woven roving with 300 g/m² and was sourced from PHD.

All raw materials except for the catalyst were degassed under reduced pressure prior to use, and the polyols were additionally dried.

Production of the Polyurethanes Used as Matrix Material

Unless stated otherwise, the polyurethanes were produced by heating the two components (polyisocyanate and polyol) to 23° C., mixing in the ratio of 1.0:1.0 NCO:OH, adding the catalyst in the specified amount and mixing the overall mixture in a Speedmixer DAC 150.1 FVZ from Hauschild for 60 seconds at 2750 min⁻¹.

Thereafter, the mixture was poured into a suitable mold and cured in an oven. This involved using the following heating program: 1 hour at 80° C.+2 hours at 150° C.

### INVENTIVE EXAMPLES OF RESIN MIXTURES

### Working Example 1

Desmodur N 3600 and glyerol (NCO:OH=1) were mixed with DBTL (0.005% by weight), a plate was poured and cured. The glass transition temperature was 98° C., the transmittance was 92%. The plates were weathered (UVB in accordance with DIN EN ISO 11507). After 1000 hours of weathering, the L value barely changed from 97.1 to 96.2. The finished reaction mixture exhibited a pot life at 23° C. of >2 hours.

### Working Example 2

Desmodur XP 2838 and glycerol (NCO:OH=1) were mixed with DBTL (0.005% by weight), a plate was poured and cured. The glass transition temperature was 118° C., the transmittance was 91%. The plates were weathered (UVB in accordance with DIN EN ISO 11507). After 1000 hours of weathering, the L value barely changed from 96.6 to 95.5. The finished reaction mixture exhibited a pot life at 23° C. of >2 hours.

### Working Example 3

Desmodur XP 2489 and glycerol (NCO:OH=1) were mixed with DBTL (0.01% by weight) at 50° C., a plate was poured and cured at 80° C. for 2 hours, 150° C. for 2 hours and 170° C. for 2 hours. The glass transition temperature was 160° C., the transmittance was 89%. The finished reaction mixture exhibited a pot life at 23° C. of >2 hours.

### Working Example 4

Desmodur N 3600 and a polyol mixture of glycerol and TMP (50:50% by weight) were mixed with DBTL (0.01% by weight) at 50° C. (NCO:OH=1), a plate was poured and cured. The glass transition temperature was 109° C., the transmittance was 92%. The finished reaction mixture exhibited a pot life at 23° C. of >2 hours.

### Working Example 5

Desmodur N 3600 and TMP (NCO:OH=1) were mixed with DBTL (0.01% by weight) at 50° C., a plate was poured and cured. The glass transition temperature was 116° C., the transmittance was 90%. The finished reaction mixture exhibited a pot life at 23° C. of >2 hours.

### NONINVENTIVE EXAMPLES OF RESIN MIXTURES

### Comparative Example 1

Desmodur XP 2838 and Desmophen 4011 T (NCO:OH=1) were mixed with DBTL (0.01% by weight), a plate was poured and cured. The glass transition temperature was 66° C., the transmittance was 92%. The plates were weathered for 1000 hours (UVB in accordance with DIN EN ISO 11507). The L value deteriorated considerably from 96.9 to 84.4.

### Comparative Example 2

Desmodur N 3600 and glycrol (NCO:OH=1.5) were mixed with DBTL (0.005% by weight), a plate was poured and cured. The glass transition temperature was 80° C., the transmittance was 92%.

### Comparative Example 3

Desmodur N 3600 and triethanolamine (NCO:OH=1) were mixed with DBTL (0.005% by weight). The mixture heated immediately (reaction, pot life under 1 min) and could not be processed further.

### Comparative Example 4

Desmodur N 3600 and Desmophen VP LS 2249/1 (NCO:OH=1) were mixed with DBTL (0.01% by weight), a plate was poured and cured. The glass transition temperature was 56° C., the transmittance was 93%.

The experiments show that the inventive resin mixtures of Working Examples 1 to 5 have a good balance among the required characteristic parameters good transmittance, high glass transition temperature, good weathering stability and long pot life, whereas Comparative Examples 1 to 4 achieved in at least one characteristic parameter only inadequate values, For instance, the glass transition temperature (Tg) in Comparative Experiments 1 to 4 is too low, the weathering stability when using polyether in Comparative Experiment 1 is too low, and the pot life when adding amine in Comparative Experiment 3 is so low that it is not possible to process the resin mixture further to give a composite material by means of common industrial processes.

Inventive Examples of Composite Polyurethane Materials

### Working Example 6

Using the reaction mixture composed of Desmodur N 3600+glycerol+0.01% by weight of DBTL; NCO:OH=1, a woven glass fiber fabric (300 g/m²) was laminated by the hand lay-up process. Thereafter, the hand lay-up laminate was cured. It had a proportion of glass fibers of 75% by weight. The DMA measurement yielded a Tg of 113° C. and a modulus E′ (20° C.) of 7.9 GPa. The sample was sample weathered for 1027 h in accordance with DIN EN ISO 16474/3 method C cycle 4 (UVB test). The sample exhibited a very weak yellowing: the delta b value was 4.7. The E′ modulus showed no difference in the sample before and after the weathering.

### Working Example 7

Using a reaction mixture composed of Desmodur N 3600+polyol (D-sorbitol dissolved in glycerol 30:70% by weight) and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 75% by weight. The DMA measurement yielded a glass transition temperature of 119° C. and a modulus E′ (20° C.) of 7.0 GPa.

### Working Example 8

Using a reaction mixture composed of Desmodur N 3600+polyol (TMP dissolved in glycerol 58:42% by weight) and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 75% by weight. The DMA measurement yielded a glass transition temperature of 111° C. and a modulus E′ (20° C.) of 8.0 GPa.

### Working Example 9

Using a reaction mixture composed of Desmodur N 3600+polyol (glycol dissolved in glycerol 50:50% by weight) and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 75% by weight. The DMA measurement yielded a glass transition temperature of 107° C. and a modulus E′ (20° C.) of 7.7 GPa.

### Working Example 10

Using a reaction mixture composed of Desmodur N 3600+glycol and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 78% by weight. The DMA measurement yielded a glass transition temperature of 95° C. and a modulus E′ (20° C.) of 8.4 GPa.

### Working Example 11

Using a reaction mixture composed of Desmodur N 3600+glycol and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 78% by weight. The DMA measurement yielded a glass transition temperature of 95° C. and a modulus E′ (20° C.) of 9.6 GPa.

### NONINVENTIVE EXAMPLES OF COMPOSITE POLYURETHANE MATERIALS

### Comparative Example 5

Using a reaction mixture composed of Desmodur N 3600+1,2,6-hexanetriol and 0.01% by weight of DBTL (NCO:OH=1), a woven glass fiber fabric (300 g/m²) was laminated by the hand lay-up process. Thereafter, the hand lay-up laminate was cured. It had a proportion of glass fibers of 72% by weight. The DMA measurement yielded a first glass transition temperature at 25° C. and a further glass transition temperature at 99° C. The modulus E′ (20° C.) was 4.0 GPa.

### Comparative Example 6

Using a reaction mixture composed of Desmodur N 3600+triethanolamine and 0.01% by weight of DBTL (NCO:OH=1), a woven glass fiber fabric (300 g/m²) was laminated by the hand lay-up process. The reaction started immediately, meaning that work had to be carried out quickly. Thereafter, the hand lay-up laminate was cured. It had a proportion of glass fibers of 71% by weight. The DMA measurement yielded a glass transition temperature at 78° C. The modulus E′ (20° C.) was 7.1 GPa.

### Comparative Example 7

Using a reaction mixture composed of Desmodur N 3600+polyol (mixture of triethanolamine+TMP 90:10% by weight) and 0.01% by weight of DBTL (NCO:OH=1), a woven glass fiber fabric (300 g/m²) was laminated by the hand lay-up process. The reaction started immediately, meaning that work had to be carried out quickly. Thereafter, the hand lay-up laminate was cured. It had a proportion of glass fibers of 72% by weight. The DMA measurement yielded a glass transition temperature at 81° C. The modulus E′ (20° C.) was 6.2 GPa.

### Comparative Example 8

Using the reaction mixture Desmodur N 3600+Desmophen 4011T+0.01% by weight of DBTL (NCO:OH=1), a woven glass fiber fabric (300 g/m²) was laminated by the hand lay-up process. Thereafter, the hand lay-up laminate was cured. It had a proportion of glass fibers of 75% by weight. The sample was weathered for 1027 h in accordance with DIN EN ISO 16474/3 method C cycle 4 (UVB test). The sample exhibited a distinct yellowing and the delta b value was 7.3. Moreover, the E′ modulus deteriorated by 15% in comparison with the sample before the weathering.

The experiments show that the inventive composite polyurethane materials according to Working Examples 6 to 11 have a good balance among the required characteristic parameters high glass transition temperature, good weathering stability, long pot life and high modulus E′, whereas the noninventive comparative examples achieved in at least one characteristic parameter only inadequate values. For instance, the modulus E′ in Comparative Experiment 5 is too low, whereas the pot life and the glass transition temperature (Tg) in Comparative Experiment 6 and 7 are too low. Comparative Example 8 shows that the yellowing is generally distinctly higher in the presence of many ether groups in the composite material and reaches unacceptable values, and that also the inherent weathering stability is distinctly worse in the presence of ether groups and this has negative effects on the mechanical properties of the composite material.

1.-17. (canceled)

18. A composite polyurethane material comprising polyurethane and at least one filler, the polyurethane being formed from a polyisocyanate component and a polyol component, wherein
(a) the polyisocyanate component consists of one or more polyisocyanates and the polyisocyanate component has an average NCO functionality per molecule of ≥2;
(b) the polyol component has an OH content of ≥30% by weight and a content of ester and/or ether groups of less than 20% by weight and the polyol component consists of one or more polyols, the average OH functionality per molecule being ≥2; and
(c) the filler is a fibrous filler.

19. The composite polyurethane material as claimed in claim 18, wherein the polyisocyanate component has an average NCO functionality per molecule of ≤4 and/or the polyol component has an average OH functionality per molecule of ≤6.

20. The composite polyurethane material as claimed in claim 18, wherein the polyisocyanate component consists of aliphatic polyisocyanates to an extent of over 80% by weight.

21. The composite polyurethane material as claimed in claim 18, wherein the polyisocyanate component has an NCO content ≥10% by weight and ≤61% by weight.

22. The composite polyurethane material as claimed in claim 18, wherein at least one polyisocyanate is an allophanate, a biuret, a uretdione or a trimer of a di- or triisocyanate.

23. The composite polyurethane material as claimed in claim 22, wherein the di- or triisocyanate is selected from the group consisting of hexane diisocyanate, isophorone diisocyanate, diisocyanatodicyclohexylmethane, xylylene diisocyanate, tetramethylxylylene diisocyanate, trimethylhexane diisocyanate, hydrogenated xylylene diisocyanate, hydrogenated toluene diisocyanate, pentane diisocyanate, norbornene diisocyanate, and 4-isocyanatomethyl-1,8-octane diisocyanate.

24. The composite polyurethane material as claimed in claim 18, wherein at least one polyisocyanate is a urethane prepolymer, the urethane prepolymer having a content of ester and/or ether groups of less than 20% by weight.

25. The composite polyurethane material as claimed in claim 18, wherein the polyol component has an OH content of ≥30% by weight and ≤60% by weight.

26. The composite polyurethane material as claimed in claim 18, wherein the molecular ratio of polyisocyanate to polyol is set such that the ratio of the NCO groups to OH groups is in the range from 0.85:1.00 to 1.20:1.00.

27. The composite polyurethane material as claimed in claim 18, wherein the polyol component has a content of amino groups of less than 9% by weight.

28. The composite polyurethane material as claimed in claim 18, wherein the fibrous filler is selected from inorganic fibers, organic fibers, natural fibers or mixtures thereof.

29. The composite polyurethane material as claimed in claim 28, wherein the fibrous filler contains inorganic fibers, especially glass fibers.

30. The composite polyurethane material as claimed in claim 18, wherein the fibrous filler proportion is ≥5% by weight and ≤95% by weight, based on the total weight of the composite polyurethane material.

31. A process for producing a composite polyurethane material as claimed in claim 18, wherein the polyisocyanate component and the polyol component are mixed, optionally a catalyst and/or additives are added, the resulting mixture is combined with the fibrous filler and optionally heated.

32. The process as claimed in claim 31, wherein the mixture has at 23° C. a pot life of at least 20 min, 30 min, 60 min or 120 min.

33. The process as claimed in claim 31, wherein the process is selected from infusion process, prepreg process for producing preimpregnated fibers, pultrusion process, precision winding process, reaction injection molding process and composite spray molding.

34. A structural component comprising the composite polyurethane material as claimed in claim 18, wherein the structural component is selected from the group consisting of profiles, carriers, reinforcing struts, reinforced lightweight component, duct covers, plates, housings, luggage compartment, engine compartment covers, bumpers, visors, skirts, pipes, pressure vessels, and tanks.
